(19) United States
(12) Patent Application Publication
(10) Pub. No.: US 2017/0223928 A1
(43) Pub. Date: Aug. 10, 2017

(54) SYSTEM AND APPARATUS FOR REMOTELY COMFORTING AND INTERACTING WITH AN ANIMAL, AND AN ANIMAL BED

(71) Applicant: CARISSA DAVINO, CHICAGO, IL (US)

(72) Inventor: CARISSA DAVINO, CHICAGO, IL (US)

(21) Appl. No.: 15/019,866

(22) Filed: Feb. 9, 2016

(51) Int. Cl. A01K 15/02; H04N 7/18; G06F 3/01; A01K 29/00

(52) U.S. Cl. CPC A01K 15/021; A01K 29/00; A01K 15/025; H04N 7/188; G06F 3/01

(57) ABSTRACT

An apparatus for comforting and interacting with an animal. The apparatus include a communication module, an input module, an output module, and a processing unit. The communication module receives a user input from an external device and the input module receives an animal input from the animal. The output module consists of at least one selected from the group of a heat generator and a vibration generator. The processing unit receivers the user input from the communication module and receives the animal input from the input module. The processing unit further operates the output module based on at least one of the user input and the animal input and transmits a signal based on the animal input to the external device using the communication module.

### TECHNICAL FIELD

The present invention relates to a system and apparatus for remotely comforting and interacting with an animal. Specifically, the present invention relates to an animal bed with an apparatus which allows a user (i.e., animal owner) to provide comfort and interaction to the animal from an external device.

### BACKGROUND

Owners of pets (i.e., animals) provide interaction and comfort to their pets when they are in the same general location, such as a home. Pet owners are often required to leave their pets alone and unsupervised for several days when they leave home for travel. As a result, pets do not receive interaction and comfort, and may become sad, bored, or lethargic when left alone. Alternatively, some pets become mischievous when left alone.

One attempted solution to a lack of interaction and comfort for pets has been to hire pet sitters who may take care of pets while the pet owner is away. In some cases, the pet owner may never know that the pet sitter did not interact with the pet for more than a few minutes. Even if the pet sitter who plays with the pet, the pet owner does not receive the direct benefit of interacting with their pet personally.

Other attempted solutions have included using automatically controlled toys, passive surveillance systems providing one-directional monitoring of the pet, and telephone systems that allow the pet owner and the pet to briefly interact with each other. While some of these solutions provide minimal interaction, each of these passive and active systems has its own drawbacks. Furthermore, the pet may need to be comforted when the pet owner is not able to interact via an active system.

Accordingly, a system and apparatus for comforting and interacting with pets would be desirable.

### SUMMARY

The present invention relates to an apparatus for comforting and interacting with an animal. The apparatus include a communication module, an input module, an output module, and a processing unit. The communication module receives a user input from an external device and the input module receives an animal input from the animal. The output module consists of at least one selected from the group of a heat generator and a vibration generator. The processing unit receivers the user input from the communication module and receives the animal input from the input module. The processing unit further operates the output module based on at least one of the user input and the animal input and transmits a signal based on the animal input to the external device using the communication module.

The present invention also relates to a system for comforting and interacting with an animal. The system includes an application on an external device and an apparatus. The application on the external device receives a user input, transmits a first signal based on the user input, receives a second signal from the apparatus, and presents information related to the animal based on the second signal. The apparatus includes a communication module, a memory module, an input module, an output module, and a processing unit. The communication module receives the first signal, based on the user input, from the application and transmits a second signal, based on an animal input, to the application. The memory module stores a stored setting and the input module receives the animal input. The output module is operable based on at least one of the user input from the application and the stored setting from the memory module. The processing unit operates the communication module, the memory module, the input module, and the output module. The processing unit further determines whether to operate the output module in one of an interacting mode and a comforting mode based on at least one of the user input and the animal input. During the interacting mode the output module presents the user input to the animal and during the comforting module the output module presents the stored setting to the animal.

The present invention further relates to a bed for an animal. The bed includes an apparatus, a top member, and a bottom member. The apparatus provides at least one of comfort and interaction to the animal. The top member includes an aperture for removably receiving the apparatus. The bottom member includes means for attaching to the top member. The top member and the bottom member are composed of at least one material.

Other advantages and features of the disclosure will become apparent upon review of the detailed description and accompanying drawings.

### BRIEF DESCRIPTION OF THE DRAWINGS

FIG. 1 illustrates an top view of an animal bed, in accordance with the principles of the present invention;

FIG. 2 illustrates an assembly view of the animal bed, in accordance with the principles of the present invention;

FIG. 3 illustrates a perspective view of an apparatus, in accordance with the principles of the present invention;

FIG. 4 illustrates a system overview of a system, in accordance with the principles of the present invention;

FIG. 5 illustrates a block diagram of the apparatus, in accordance with the principles of the present invention; and

FIG. 6 illustrates a flowchart of a process for comforting and interacting with an animal, in accordance with the principles of the present invention.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

Accordingly, the detailed discussion herein of one or more embodiments is not intended, nor is to be construed, to limit the metes and bounds of the patent protection afforded the present invention, in which the scope of patent protection is intended to be defined by the claims and equivalents thereof. Therefore, embodiments not specifically addressed herein, such as adaptations, variations, modifications, and equivalent arrangements, should be and are considered to be implicitly disclosed by the illustrative embodiments and claims described herein and therefore fall within the scope of the present invention.

Additionally, it is important to note that each term used herein refers to that which a person skilled in the relevant art would understand such term to mean based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

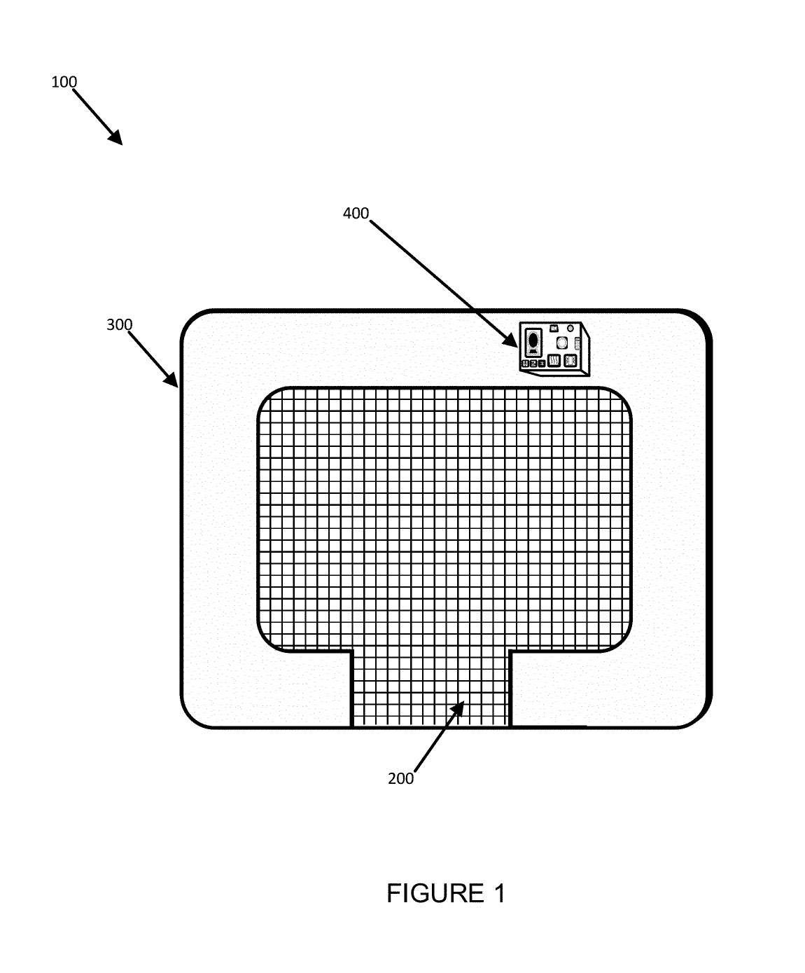

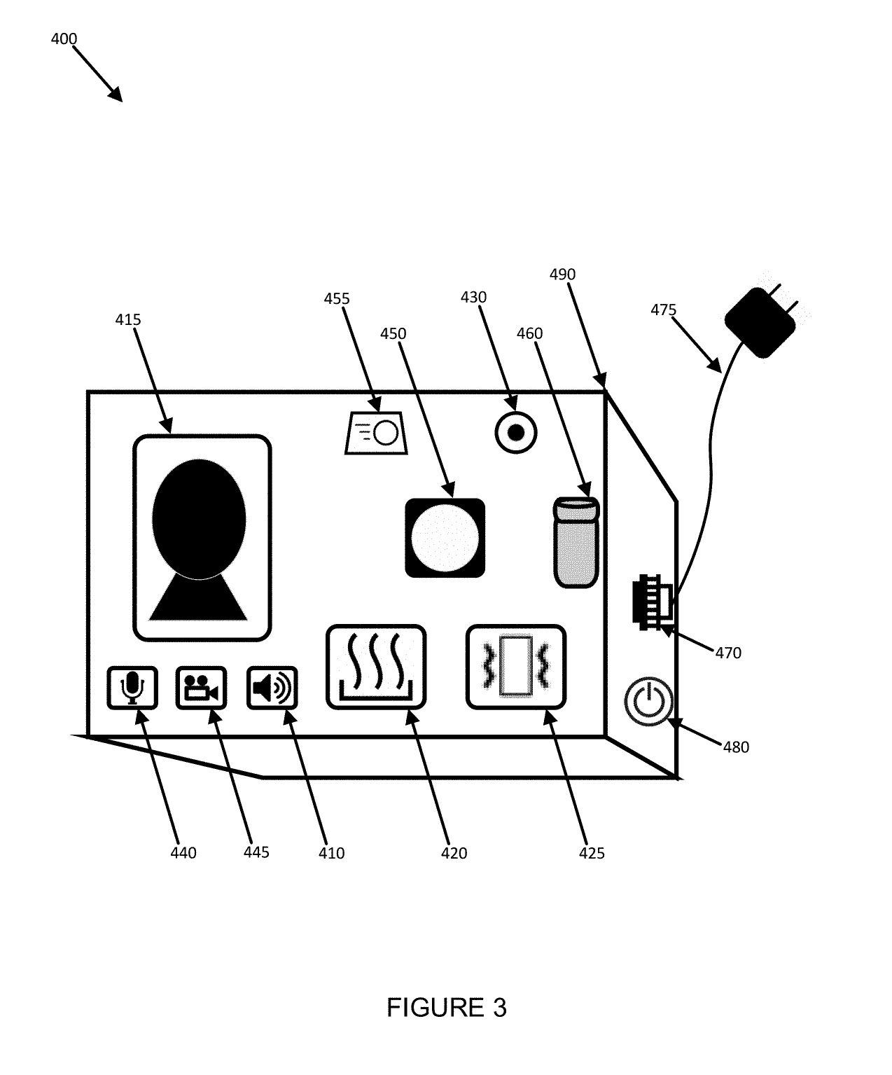

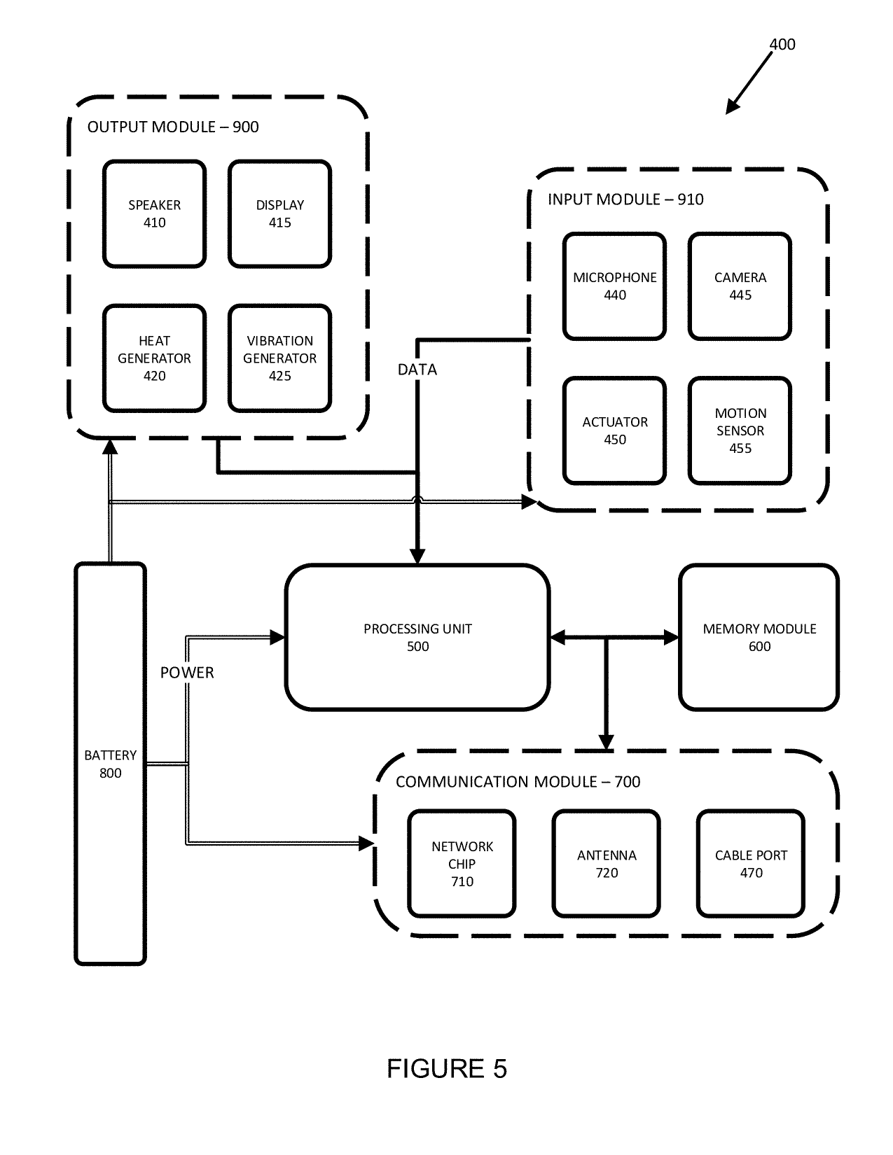

FIG. 1 illustrates an animal bed 100 (i.e., gas monitor, portable gas device, multi-gas detector) in accordance with an embodiment of the present invention. The animal bed 100 includes a plurality of apparatus 400, a top member 300, and a bottom member 200. The animal bed 100 provides a space for an animal (i.e., a pet) to sleep or relax. The animal may be, but is not limited to, a dog, a cat, or another domesticated mammal. The animal lies on the bottom member 200 and may press against the top member 300 for support. In some embodiments, the top member 300 has a cylindrical cross-section. In other embodiments, a plurality of top members 200 may be used with one bottom member 200. The apparatus 400 is removably received in some embodiments by the top member 300 and in some by the bottom member 200, and in other embodiments an apparatus 400 could be received by the top and the bottom members 300,200, and provides comfort and interaction for the animal (more detail in reference to FIGS. 3 and 5).

The animal bed 100 depicted in FIG. 1 has a rectangular shape, but other shapes may be used. A person skilled in the art would have sufficient knowledge to understand that the animal bed 100 can have a shape such as, but not limited to, circular, triangular, cylindrical, or even an undefined shape which could be substantially wavy, substantially elliptical, and/or substantially oblong. Additionally, the top member 300 is depicted having an opening and not enclosing the bottom member 200. The opening allows easier entry and exit for the animal into the animal bed. In some embodiments, the top member 300 encloses the bottom member 200. In other embodiments, the top member 300 encloses the bottom member 200 and has a portion with a reduced height, or even in some embodiments a gap, that provides a partial opening for the animal to enter and exit the animal bed 100.

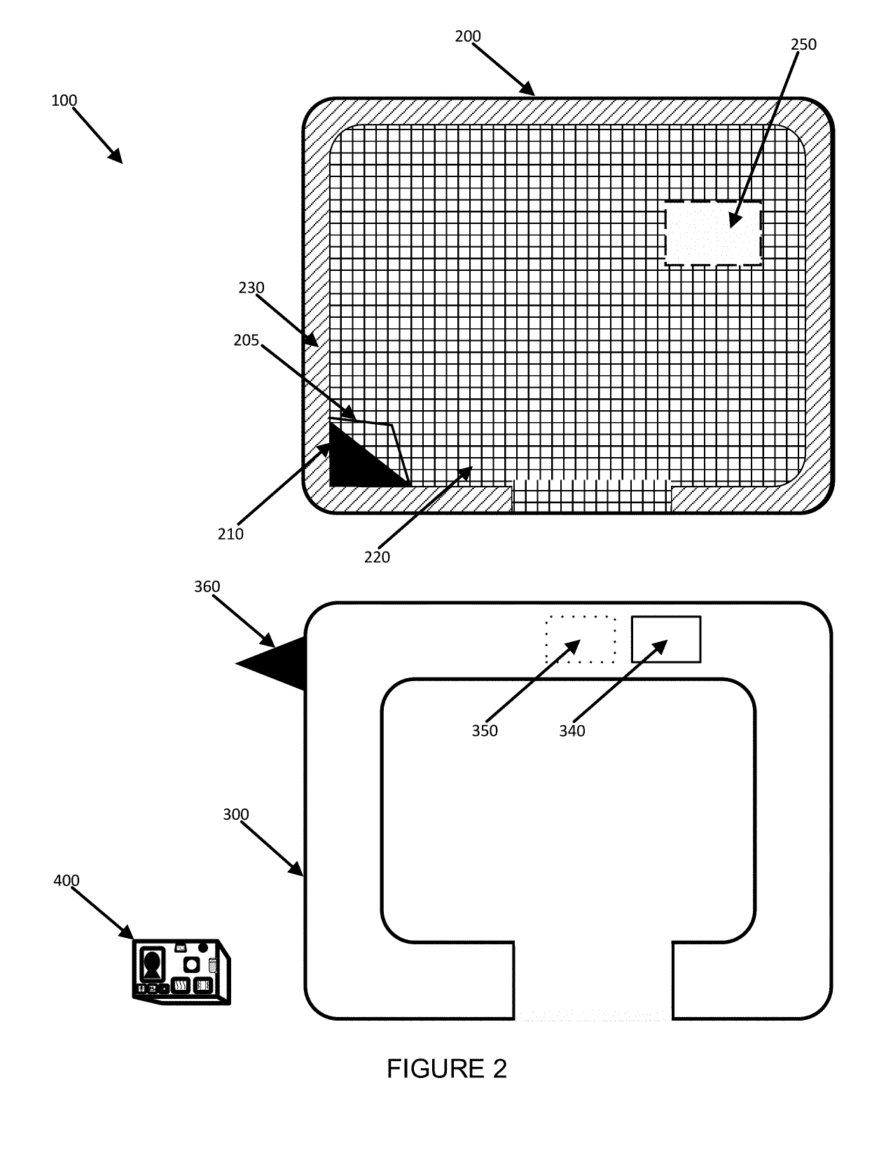

FIG. 2 illustrates an assembly view of the animal bed 100 in accordance with an embodiment of the present invention. The bottom member 200 is removably attached to the top member 300 and in FIG. 2 is disassembled therefrom. The top member 300 or the bottom member 200 could include an aperture 340 operable to removably receive the apparatus 400. In FIG. 2, the apparatus 400 is accommodated in the top member 300. The aperture 340 holds the apparatus 400 in place so that the animal can interact with the apparatus 400. Additionally, the aperture 340 may provide protection to the apparatus 400 from scratches or saliva of the animal, using, for example, but not limited to, a plastic screen. An animal owner may remove the apparatus 400 from the aperture 340 to adjust settings, perform maintenance, charge a battery, and other functions. When the aperture 340 is empty, the top member 300 (or bottom member 200 if the apparatus 400 is accommodated thereby) may be washed without damaging the apparatus 400.

In some embodiments, the top member 300 further includes a plurality of compartments 350 and a plurality of toggles 360. A compartment 350 can store an object other than the apparatus 400 and make the object inaccessible to the animal. An object stored in the compartment 350 may be, for example, but is not limited to, a cable for the apparatus 400, a toy for the animal, and a peripheral device. The toggle 360 is operable to attach an additional feature to the top or bottom member 300,200. The additional feature may be, for example, but not limited to, an automatic treat dispenser, a covering for the animal bed 100, an air freshener, and an animal toy. The animal is able to access the additional feature. The toggle 360 may be composed of, for example, but not limited to, wood, plastic, or another suitable material which is non-hazardous and durable in the event of chewing and/or ingestion. A toggle 360 could be accommodated by the bottom member 200 in another embodiment. A further embodiment provides a toggle member 360 on the top and the bottom members 300, 200.

The bottom member 200 in FIG. 2, includes attaching means 230, an opening 205, a first material 210, and a second material 220. In other embodiments, the bottom member 200 only includes a singe material. The attaching means 230 are operable to attach the top member 300 to the bottom member 200. The attaching means 230 may be, for example, but are not limited to, Velcro® (i.e., a hook and loop fastener), a zipper, a plurality of clips, a plurality of buttons, a plurality of stitches, or an adhesive. In some embodiments, it is preferable for the attaching means 230 to removably attach the bottom member 200 to the top member 300 so that the members 200, 300 can be washed separately.

In some embodiments, the bottom member 200 is composed of multiple materials and includes the opening 205 to access the multiple materials. The first material 210 could provide rigidity to the bottom member 200 and insulation and cushioning for the animal. The first material may be, for example, but not limited to, cotton, foam, or down (i.e., feathers). The second material 220 covers the first material 210 and preferably provides a soft exterior surface on which the animal rests inside the animal bed 100. The second material may be, for example, but not limited to, fleece, silk, cotton, suede, nylon, polyester, or another suitable materials. A person skilled in the art would have sufficient knowledge of other suitable materials for the first material 210 and the second material 220 of the animal bed 100. Both the first and second materials 210, 220 of the bottom member and the material from with the top member are formed could be a plurality of materials in addition to those already mentioned, such as, but not limited to, waterproof, water resistant, polyester, and polyurethane. These materials are known to be useful in accommodating allergies, for example to dust mites and dead skin cells.

The opening 205 provides access to the first material 210 and the second material 220. The second material 220 gathers dirt, hair, and skin from the animal during usage, and may harbor fleas or ticks if the animal is infected. Thus, the second material 220 should be washed frequently to provide a hygienic surface for the animal to rest on. Similarly, the first material 210 and the top member 300 may be washed. In some embodiments, the members 200, 300 have chemical coatings that reduce the amount of dirt, hair, and skin gathered by the materials 210, 220.

In some embodiments, the bottom member 200 further includes a compartment 250. Similar to the compartment 350 of the top member 350, the compartment 250 of the bottom member 200 can store an object other than the apparatus 400 and make the object inaccessible to the animal. The object stored in the compartment 350 may be, for example, but is not limited to, a cable for the apparatus 400, a toy for the animal, and a peripheral device.

The material of the top and/or bottom member 300, 200, can also be provided with a brush which can be removable or affixed to the material whereby the animal can scratch, groom, or otherwise rub against the same, and such brush can in a removable embodiment be removed and the bristles cleaned as needed or removed for washing the material. The bristles can serve the purpose both of grooming but also for, in the event of chewing, clean the animals teeth. The bristles, therefore, could be made of any material which is suitable including, but not limited to, resilient plastics, rubbers, and wood.

FIG. 3 illustrates an apparatus 400 in accordance with an embodiment of the present invention. The apparatus 400 includes an enclosure 490, a power switch 480, a cable port 470, and various components for comforting and interacting with an animal. The enclosure 490 provides protection to the apparatus 400 from teeth or claws of the animal. The enclosure 490 may be composed of, for example, but not limited to, plastic, rubber, latex, or another suitable material. A person skilled in the art would have sufficient knowledge of other suitable materials for enclosure 490 of the apparatus 400.

The power switch 480 begins operation of the apparatus 400, enabling the apparatus 400 to draw power from a battery (more detail in reference to FIG. 5). In an embodiment, an animal owner actuates the power switch 480 to turn the apparatus 400 on before leaving the animal so that the apparatus 400 provides comfort and interaction to the animal. Upon returning to the animal, the owner actuates the power switch 480 to turn the apparatus 400 off. In a further embodiment, the on/off function of the apparatus 400 operation can be remotely controlled, automatically adjusted depending on various inputs at parameters, and automatically set according to a time table. In one embodiment, the bottom member could be further provided with a scale therein whereby the weight of the animal could be gauged and transmitted to the owner over a wireless system or by Bluetooth technology for instance; and/or, a scale could be used to trigger the on/off function whereby the parameter programmed would include whether the weight of the animal is detected for a certain amount of time (e.g. but not limited to, ten seconds, thirty seconds, one minute, five minutes), and if the animal weight is not detected after that time, then the apparatus 400 is turned off, or in another embodiment, could be programmed to be in a standby mode.

The cable port 470 may include a Universal Serial Bus (“USB”) socket into which a cable 475 can be inserted. The cable port 470 allows the animal bed 100 to be field-programmable, that is, the animal bed 100 can be reconfigured, modified, or upgraded via the diagnostic 550. In some embodiments, the cable port 470 also functions as a charging port for providing a charging current to the battery. The power switch 480 and the cable port 470 are preferably located on a side of the apparatus 400 that is not accessible to the animal when the apparatus 400 is received by the aperture 340 of the top member 300.

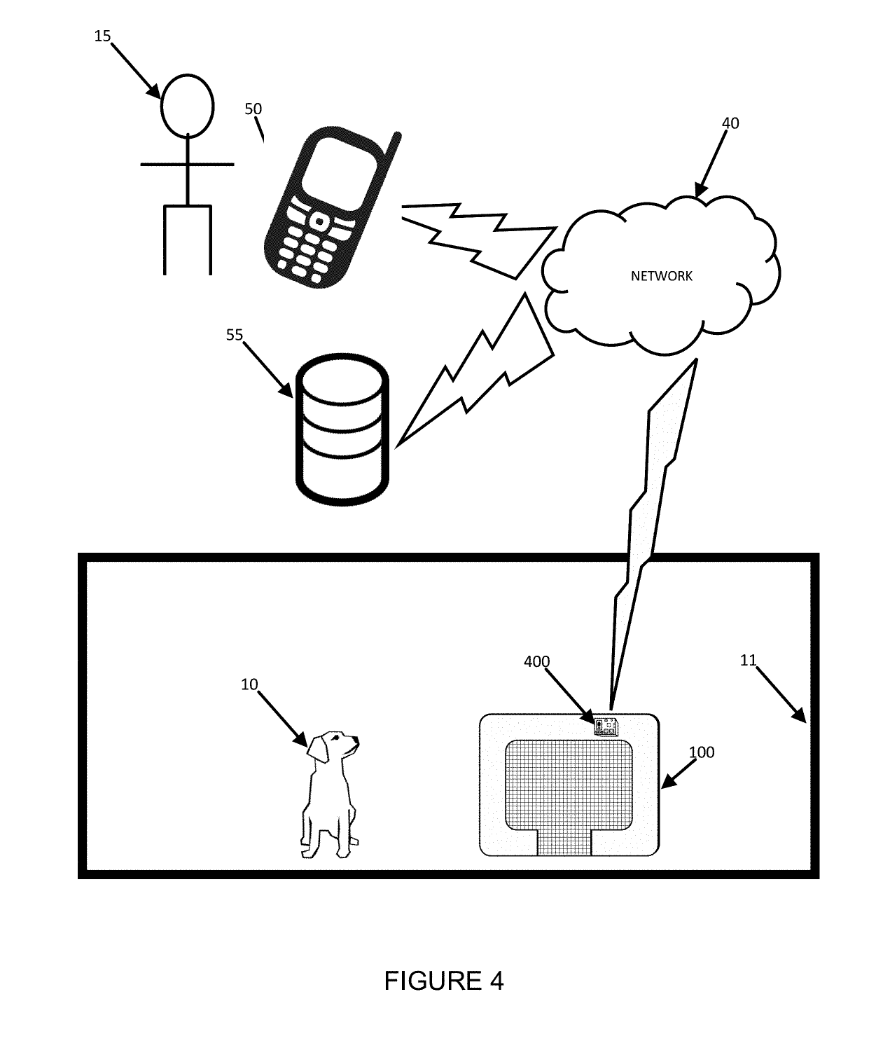

Referring to FIG. 3, the apparatus 400 includes a speaker 410, a display 415, a heat and cooling generator 420 (i.e., heat source, heat emitter, fan, cooling source), a vibration generator 425 (i.e., motion generator, vibrating motor), a laser 430, a microphone 440, a camera 445, an actuator 450, a motion sensor 455, and a sample vial 460. The heat and cooling generator 420 could for cooling purposes, include an encapsulated phase change material (“PCM”) such as wax, a gel, paraffin, or water, and could also include a metal such as aluminum or graphite whereby once cooled, the PCM maintains its cool temperature more readily preserving the battery longer and yet keeping the lower temperature due to a slower discharge of a PCM. Generally, components 410 through 430 output various stimuli to comfort and interact with the animal, while components 440 through 460 record various stimuli that may be transmitted to the animal owner (more detail in reference to FIGS. 4-6).

In some embodiments, components 410 through 460 and other electronic components of the apparatus 400 are fixed to a plurality of printed circuit boards (“PCB”). The PCB mechanically supports and electrically connects components of the animal bed 100 using tracks, pads, and other features etched from conductive sheets laminated onto a non-conductive substrate. The PCB may be custom-designed for optimal placement of the components 410 through 460 and other components within the apparatus 400. The placement of the components 410 through 460 on the apparatus 400 depicted in FIG. 3 is merely for illustrative purposes; other placements are possible.

The speaker 410 outputs audio signals into the area around the apparatus 400. In some embodiments, the speaker 410 is operable to output audio signals such as, but not limited to, a human (i.e., the animal owner) voice, a heartbeat, white noise, and/or music. The audio signal may be based on a stored setting in a memory module or a signal transmitted from an external device connected to the apparatus 400 over a network (more detail in reference to FIGS. 4 and 5). In other embodiments, a plurality of speakers 410 may be used.

The display 415 is operable to output visual signals such as, but not limited to, an image or a video of a human, another animal, and/or comforting lights. The visual signal may be based on a stored setting in a memory module or a user input received from an external device connected to the apparatus 400 over a network (more detail in reference to FIGS. 4 and 5). The display 415 is, for example, a liquid crystal display (“LCD;” monochrome or color), a light-emitting diode (“LED”) display, an organic LED (“OLED”) display, a field emission display (“FED”), a thin-film transistor (“TFT”) LCD, or another suitable display technology. In use, for instance, the lights could dim, slow, or turn off depending on the stored settings, automatically, by remote control and/or by manual manipulation.

The heat and cooling generator 420 outputs heat to comfort the animal. The heat and cooling generator 420 uses, for example, electrical resistivity or infrared light to generate heat. In some embodiments, an electrical current passing through a length of resistive wire emits heat. In other embodiments, an electrical current passing through a ceramic material emits infrared waves, which can be felt by the animal as heat. A person skilled in the art would have sufficient knowledge of other means of generating heat. The heat and cooling generator 420 may output heat at a predetermined interval or when receiving a signal transmitted from an external device.

The vibration generator 425 outputs vibrations to comfort the animal. The vibration generator 425 uses, for example, a motor coupled to a plurality of weights. In some embodiments, a rotational motor causes the plurality of weights to rotate. Each of the plurality of weights may have a different mass, causing the motor and the plurality of weights to rotate unevenly; the uneven rotation leads to vibration. In other embodiments, a linear motor causes the plurality of weights to move. A person skilled in the art would have sufficient knowledge of other means of generating vibrations. The vibration generator 425 may output heat at a predetermined interval or when receiving a signal transmitted from an external device.

In some embodiments, the heat and cooling generator 420 or the vibration generator 425 may be located outside of the plastic enclosure 490 of apparatus 400. For example, the heat and cooling generator 420 or the vibration generator 425 may be located in the compartment 250 of the bottom member 200 of the animal bed 100 or the compartment 350 of the top member 300 of the animal bed. Generators 420, 425 located externally from the apparatus 400 may wirelessly receive signals or power from the apparatus 400. It is preferable for the generators 420, 425 to receive wireless signals or power because wires to/from the apparatus 400 may be damaged by the animal or during washing of the animal bed 100.

The laser 430 outputs a laser beam to entertain the animal. The laser beam emitted by the laser 430 may surprise or excite the animal. In some embodiments, the laser 430 is moveable and the animal may chase after the laser beam. The laser 430 may output the laser beam at a predetermined interval or when receiving a signal transmitted from an external device.

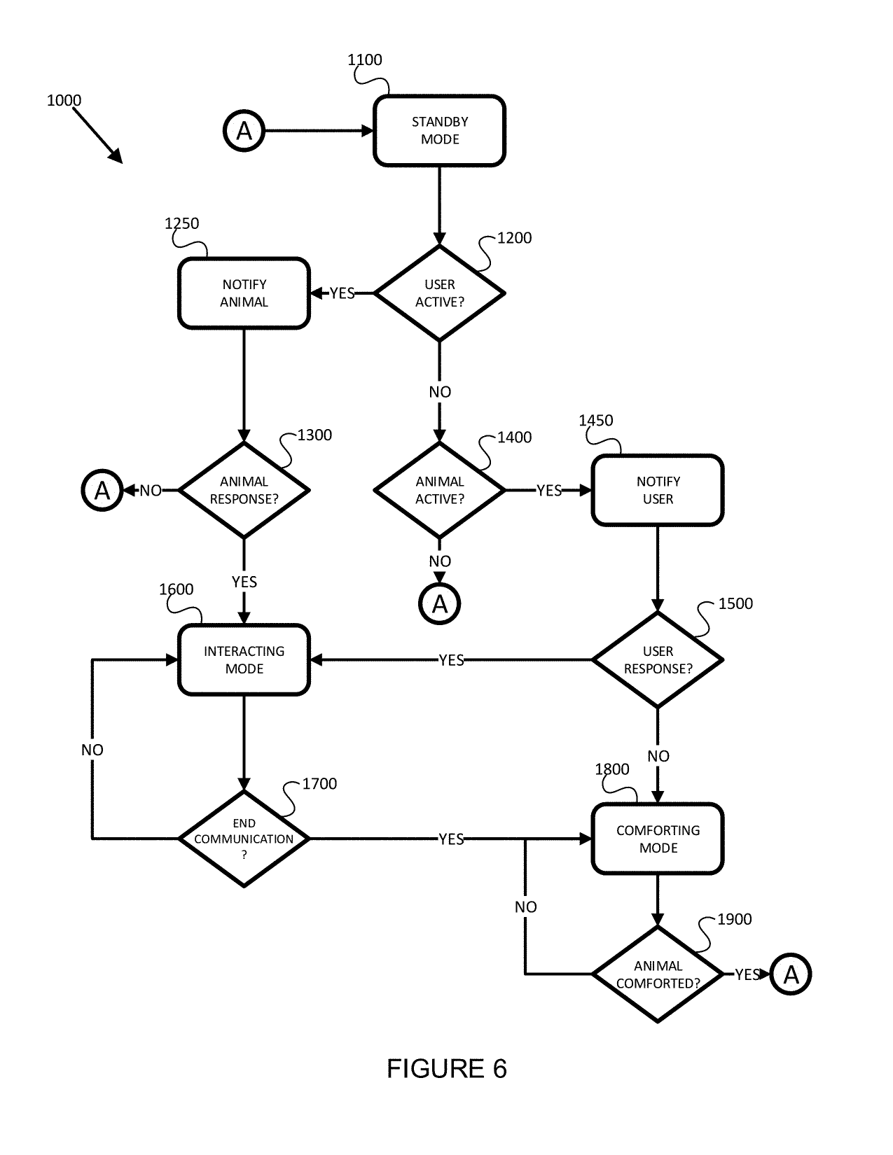

The microphone 440 receives (i.e., captures) sounds generated by the animal. The sounds may be, for example, but not limited to, a barking of a dog or a meowing of a cat. In some embodiments, the microphone 440 receiving a sound may trigger the apparatus 400 to transmit the sound to an external device of the user (more detail in reference to FIGS. 4 and 6) to allow the user to hear the animal.

The camera 445 receives (i.e., captures) a still or moving image of the animal. The still or moving image may be, in some examples, but not limited to, high definition (“HD”), standard definition (“SD”), 1080p, 1080i, 720p, and other suitable definitions. In some embodiments, the camera 445 is a video recording device with a wide angle lens which allows for a video recording of the environment in front of camera 445. In other embodiments, the camera 445 uses other digital video recording devices or other appropriate video recording devices.

A wide angle lens may be used to allow for video recording of the environment without the need to move the camera 445 to follow the animal within the field of view. Alternatively, servomotors may be used to move the camera to follow the animal. The camera 445 may have focusing capabilities which allow for focusing of the image based on a distance of the animal from the camera 445.

The actuator 450 allows an animal to provide an animal input into the apparatus 400. The actuator may be, but is not limited to, a switch, a button, a knob, and a dial. In some embodiments, the animal actuating (i.e., pressing, flipping, tripping, manipulating) the actuator 450 may trigger the apparatus 400 to transmit (directly, wirelessly, or via Bluetooth) a signal to an external device of the user (more detail in reference to FIGS. 4 and 6) to allow the user to respond.

The motion sensor 455 (i.e., motion detector) detects motion of the animal. The motion sensor 455 may be, for example, but not limited to, an infrared sensor, a microwave sensor, or an ultrasonic sensor. In some embodiments, the motion sensor 455 detecting motion may trigger the apparatus 400 to transmit the sound to an external device of the user (more detail in reference to FIGS. 4 and 6) to allow the user to see the animal (e.g., by turning on the camera 445).

In some embodiments, the apparatus 400 includes the sample vial 460. The sample vial 460 may collect a sample of saliva of the animal for analysis. In some embodiments, the apparatus 400 includes means for analyzing the sample of saliva. The apparatus 400 may transmit a signal to a veterinarian based on the saliva collected by the sample vial 460.

FIG. 4 illustrates a system overview of a system 1 for comforting and interacting with an animal 10 in accordance with an embodiment of the present invention. An animal 10 uses the animal bed 100 within a house 11. In some embodiments, a plurality of animals 10 uses a plurality of animal beds 100 within the house 11 simultaneously. The apparatus 400 of animal bed 100 is operable to communicate with a network 40 (more detail in reference to FIG. 5). In some embodiments, the apparatus 400 of the animal bed 100 communicates with a router (not shown) within the house 100 to transmit signals to the network 40.

A user 15 uses an external device 50 to transmit signals to and from the animal bed using the network 40. The user 15 may be, but is not limited to, an owner of the animal 10 (i.e., an animal owner, a pet owner) or a relative (i.e., a family member, a friend) of the owner of the animal 10. The external device 50 may be, for example, but not limited to, a cellular phone, a personal computer, a tablet. The external device 50 sends and receives signals from the animal bed 100 via the network 40. In other embodiments, the external device 50 is a single-function device that is only operable to communicate with the apparatus 400 of the animal bed 100.

In some embodiments, an application operates on the external device 15. The application may be, for example, a smartphone application or a website. The application receives a user input such as, for example, logging in, pressing a button, recording an audio and/or visual message, streaming an audio and/or visual message. The application is operable to transmit a first signal based on the user input to the apparatus 400 via the network 40. The application is further operable to receive a second signal, based on an animal input, from the apparatus 400 via the network 40. The animal input may be, for example, pressing the actuator 450, moving in front of the motion sensor 455, making a sound received by the microphone 440, or standing in view of the camera 445 (more detail in reference to FIGS. 5 and 6). The application presents information related to the animal 10 to the user 15 on the external device 50. The information related to the animal 10 may be, for example, but not limited to, a real-time audio signal from the microphone 440, a real-time image from the camera 445, a notification that the animal 10 pressed the actuator 450, or a notification that the animal 10 move in front of the motion sensor 455.

In other embodiments, a remote server 55 communicates with the apparatus 400 of the animal bed 100 via the network 40. The remote server 55 may be configured to store logs of the apparatus 400 activity. For example, the remote server 55 can be configured to provide a graphical user interface (“GUI”) that the user 10 can access using the external device 50.

FIG. 5 illustrates the apparatus 400 in a block diagram format, in accordance with an embodiment of the present invention. A processing unit 500, a memory module 600, a communication module 700, an output module 900, and an input module 910 are connected by one or more control and/or data buses (labeled “DATA”). The control and/or data buses are shown generally in FIG. 5 for illustrative purposes. The use of one or more control and/or data buses for the interconnection between and communication among the various modules and components would be known to a person skilled in the art in view of the present invention described herein.

The processing unit 500 of the apparatus 400 is, for example, but not limited to, a controller, processor, multiprocessor, microcontroller, or another suitable programmable device. The processing unit 500 includes a plurality of electrical and electronic components that provide power, operational control, and protection to the components and modules within the apparatus 400. In some embodiments, the processing unit 500 includes, among other things, a control unit, an arithmetic logic unit (“ALU”), and a plurality of registers, and is implemented using a known computer architecture, such as a modified Harvard architecture, a von Neumann architecture, etc. In some embodiments, the processing unit 500 is implemented partially or entirely on a semiconductor, for example, but not limited to, a field-programmable gate array [“FPGA”]) chip, such as a chip developed through a register transfer level (“RTL”) design process. In some embodiments, the processing unit 500 is composed of a plurality of processors.

The memory module 600 of the apparatus 400 includes, for example, a program storage area and a data storage area. The program storage area and the data storage area may include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 500 is connected to the memory module 600 and executes software instructions that are capable of being stored in a RAM of the memory module 600, for example during execution, a ROM of the memory module, 600, for instance on a generally permanent basis, or another non-transitory computer readable medium such as another memory or a disc. Software included in the implementation of apparatus 400 of the animal bed 100 can be stored in the memory module 600. The software includes, for example, firmware, one or more applications, program data, filters, rules, one or more program modules, and other executable instructions. The processing unit 500 is configured to retrieve from memory and execute, among other things, instructions related to the control processes and methods described herein. Additionally, in some embodiments, the memory module 600 may log information related to operation of the apparatus 400, such as the time span over which the apparatus 400 was operational or the operation of the communication module 700, the output module 900, and/or the input module 910.

Referring to FIG. 5, the output module 900 includes components that have been previously described with respect to FIG. 3, such as the speaker 410, the display 415, the heat and cooling generator 420, and the vibration generator 425. For subsequent disclosure, the speaker 410, the display 415, the heat and cooling generator 420, and the vibration generator 425 have been referred to as the output module 900. In some embodiments, the output module 900 includes the laser 430 (not shown in FIG. 5).

The processing unit 500 determines how to operate the output module 900 based on a user input and an animal input. The animal input may be, for example, pressing the actuator 450, moving in front of the motion sensor 455, making a sound received by the microphone 440, or standing in view of the camera 445. The output module 900 may operate in multiple operating modes such as, for example, but not limited to, an interaction mode, a comforting mode, and a standby mode. The interacting mode of the output module 900 is appropriate when, for example, the animal 10 is near or in the animal bed 100 and the user 15 is near the external device 50 and has time to interact with the animal 10. The comforting mode is appropriate when, for example, the animal 10 is near or in the animal bed 100 but the user 15 is not near the external device or does not have time to interact with the animal 10 (more detail in reference to FIG. 6).

The input module 910 includes various sensors that have been previously described with respect to FIG. 3, such as the microphone 440, the camera 445, the actuator 450, and the motion sensor 455. For subsequent disclosure, the microphone 440, the camera 445, the actuator 450, and the motion sensor 455 have been referred to as the input module 910. In some embodiments, the input module 910 includes the sample vial 460 (not shown in FIG. 5).

In some embodiments, the memory module 600 is a removable Secure Digital (“SD”) card that stores a stored setting. The stored setting is a user feature and/or an actuating interval. The user 15 may create, edit, or delete stored settings from the memory module 600 using the external device 50 and then reinsert the memory module 600 into the apparatus 400. A user feature may be, for example, but not limited to, a voice of the user 15 (i.e., the animal owner), an image of the user 15, a video of the user 15, a heartbeat of the user 15, or a song selected by the user 15. An actuating interval may be, for example, an interval for the processing unit 500 to operate the output module 900, a duration of time for the processing unit 500 to operate the output module 900, or a schedule for the processing unit to operate the output module 900.

The apparatus 400 of the animal bed 100 communicates with the network 40 via the communication module 700. The network 40 may be a wireless personal-area-network such as Bluetooth, a wireless wide-area-network such as internet, or a Global Systems for Mobile Communications (“GSM”) network. The communication module 700 is operable to transmit and receive signals via the network 40.

The communication module 700 may include, but is not limited to, a network chip 710, an antenna 720, and the cable port 470 (described above in reference to FIG. 3). The network chip 710 enables communication via the network 40 by providing access IDs or protocol information. The network chip 710 may be, for example, but not limited to, a Wi-Fi chip, a Bluetooth chip, or a GSM chip. The antenna 720 supports a connection between the apparatus 400 and the network 40. In some embodiments, a signal can be transmitted at real-time by the communication module 700 or stored in the memory module 600 until a connection between the communication module 700 and the external device 50 is established.

In other embodiments, Near Field Communication (“NFC”) or infrared (“IR”) technology is used to transmit signals between the apparatus 400 and a router (not shown) within the house 11, wherein the router transmits signals via the network 40 to and from the external device 50. It should be understood that even when the communication module 700 is transmitting to and receiving signals from the external device 50, a signal based on the data to the external device 50, the output module 900 continues to operate in one of the interacting mode and the comforting mode.

In some embodiments, the communication module 700 also includes one or more encryption chips, modems, or both for communicating with different types of external devices. For example, the communication module 700 may include an Apple® encryption chip and a supported modem, which allows the apparatus 400 to communicate with Apple® devices. The apparatus 400 can similarly include encryption chips and modems for other types of external devices, such as Microsoft® devices, Android® devices, and Linux® devices.

Referring to FIG. 5, the apparatus 400 of the animal bed 100 includes a battery 800. The battery 800 may be, for example a Lithium-ion battery (e.g., a 4-cell rechargeable battery providing 3.6 Volts). The battery 800 provides power to all electronic components of the animal bed 100, such as the processing unit 500, the memory module 600, the communication module 700, the output module 900, the input module 910, and additional sensors and modules. In some embodiments, the battery 800 may be a similar size and shape as those found on cellular phones. In other embodiments, a nickel-cadmium (“NiCd”), nickel-metal hydride (“NiMH”), or alkaline (e.g., AA) batteries are used. The battery can be rechargeable, can be recharged/charged via induction charging, and/or can be charged by a wall electrical outlet, and/or by accommodating a USB to a computer to recharge/charge the apparatus 400. Other batteries can also be used for operating apparatus 400 in the lower member 200 and/or those in the upper member 300.

Power is delivered to components of the animal bed 100 from the battery 800 over one or more power buses (labeled “POWER”). The power buses are shown generally in FIG. 4 for illustrative purposes. In some embodiments, power from the battery 800 can be conserved by placing the output module 900 in a standby mode (more detail in reference to FIG. 6). The battery 800 is preferably able to power to the apparatus 400 for several day while the user 15 is away from the house 11.

In some embodiments, the apparatus 400 is able to conserve power from the battery 800 by reducing usage of the communication module 710. For example, the apparatus 400 may not search for a transmission from the external device 50 until the animal 10 presses the actuator 450, thereby waking up the processing unit 500 and the communication module 700. In other embodiments, the communication module 700 is also configured to only be connected to the network 40 during a predefined period of time during the day.

FIG. 6 illustrates a flowchart of a process 1000 for comforting and interacting with an animal, in accordance and embodiment of the present invention. The process 1000 is associated with and described herein with respect to the system 1 depicted in FIG. 4 involving the user 15 with the external device, and the animal bed with the apparatus 400 used in the house 11 containing the animal 10. Various steps described herein with respect to the process 1000 are capable of being executed simultaneously, in parallel, or in an order that differs from the illustrated serial manner of execution. The process 1000 is also each capable of being executed using fewer steps than are shown in the illustrated embodiment

The process 1000 for comforting and interacting with the animal 10 begins with the apparatus 400 in standby mode at step 1100. During the standby mode, the output module 900 presents neither the user input—e.g., logging in, pressing a button, recording an audio and/or visual message, streaming an audio and/or visual message—nor the stored setting—e.g., a user feature and/or an actuating interval—to the animal 10 (the user input and the stored setting are described above with respect to the communication module 700 and the memory module depicted in FIG. 5, respectively). In other words, the output module 900 is not active during the standby mode.

The processing unit 500 checks whether the communication module 700 has received a signal (i.e., the first signal) from the external device 50 at step 1200. If the communication module 700 receives the first signal from the external device 50 indicating that the user 15 is active (i.e., a positive user input), the output module 500 notifies the animal 10 at step 1250. The positive user input is, for example, but not limited to, the user 15 logging in to the application related to the system 1 on the external device 15, pressing a button within the application on the external device 15, or streaming an audio and/or visual message for the system 1 on the external device 15. The notification is, for example, a ringtone, the user's voice, or other indication means by the components 410 through 430 of the output module 900.

If the communication module 700 does not receive a signal from the external device at step 1200, the processing unit 500 checks whether the output module 900 has received an animal input at step 1400. As described above, the animal input indicates that the animal 10 is near or on the animal bed 100 and may need interaction and/or comforting. If the animal is not active (i.e., a negative animal input), the apparatus 400 continues operating in standby mode (step 1100).

At step 1300, the processing unit checks whether the animal 10 has responded to the notification from the output module 900 in step 1250. If the animal has not responded (i.e., a negative animal input), the apparatus 400 remains in standby mode (step 1100). A negative animal input is, for example, but not limited to, the animal 10 not pressing the actuator 450, not moving in front of the motion sensor 455, not making a sound received by the microphone 440, or not standing in view of the camera 445.

If the animal has responded (i.e., a positive animal output) at step 1300, the apparatus 400, in particular the output module 900 of the apparatus 400, switches to operating in the interacting mode (step 1600). Another way for the apparatus 400 to switch to the interacting mode is the processing unit 500 determining that the output module 900 has received a positive animal input (described above with respect to step 1200) at step 1400, then notifying the user 15 that the animal 10 is active near or on the animal bed 100. The notification is transmitted via the network 40 and presented to the user 15 on the external 50 at step 1450. The notification is, for example, a ringtone, the animal's sound received by the microphone 440, the animal's image received by the camera 445, a notification that the animal 10 pressed the actuator 450, a notification that the animal 10 moved in front of the motion sensor 455, or other inputs received by the components 440 through 460 of the input module 910 (and subsequently transmitted by the communication module 700 via the network 4). If the user response at step 1500 is a positive user input (described above with respect to

The interacting mode of the apparatus 400 at step 1600 allows the user 15 and the animal 10 to interact in real-time or near real-time. The communication module 700 transmits the second signal based on the animal input—sounds received by the microphone 440, images received by the camera 445, notifications the animal 10 pressed the actuator 450—via the network 40 to the external device. Simultaneously (or nearly simultaneously), the communication module 700 receives the first signal based on the user input and the input module 910 presents the user input—the user's voice (as received by a microphone of the external device 10), the user's image (as received by a camera of the external device 10), heat generated in response to a user selection on the external device 10, or vibrations generated in response to a user selection on the external device 10—to the animal 10 using the respective components 440 through 460 of the input module 910.

The interacting mode (step 1600) allows the user 15 to check if the animal 10 is behaving well inside the house 11, and may calm the animal 10 because it can see its owner (i.e., the user 15). After step 1600, the user 15 may end communication via the network 40 between the external device 15 and the apparatus 400 at step 1700. Alternatively, an error at one of the external device 15, the network 40, or the communication module 700 of the apparatus 400 may end the communication at step 1700. If the communication is ended at step 1700, the apparatus 400, in particular the output module 900 of the apparatus 400, switches to operating in the comforting mode (step 1800). If the communication is not ended at step 1700, the apparatus 400 remains in interacting mode.

The comforting mode of the apparatus 400 at step 1800 allows the output module 900 to provide comfort to the animal 10 without user input. In comforting mode, the output module 900 presents the stored setting from the memory module 600 to the animal 10. As described above with respect to FIG. 5, the stored setting is a user feature and/or an actuating interval. A user feature may be, for example, but not limited to, a voice of the user 15, an image of the user 15, a video of the user 15, a heartbeat of the user 15, or a song selected by the user 15. The stored setting (i.e., the user feature) is presented to the animal 10 using the respective components 440 through 460 of the input module 910—the voice or song is presented by the speaker 410, the image or video is presented by the display 415, the heartbeat is presented by the vibration generator 425.

An actuating interval of the stored setting may be, for example, an interval for the processing unit 500 to operate the output module 900, a duration of time for the processing unit 500 to operate the output module 900, or a schedule for the processing unit to operate the output module 900. At the appropriate time (based on the interval, the duration, and/or the schedule), the output module activates the components 440 through 460. In some embodiments, the heat and cooling generator 420 outputs heat based on a pre-set duration or temperature setting (also stored in the memory module 600). In other embodiments, the speaker 420 outputs a sound, the display outputs an image, and the vibration generator 425 outputs a vibration.

The process 1000 can also get the apparatus 400, in particular the output module 900 of the apparatus, to operate in the comforting mode (step 1800) depending on the result of the user notification at step 1450. If the user response is a positive user input (described above with respect to step 1200) at step 1500, the interacting mode (step 1600) is selected. On the other hand, if the user response is a negative user input at step 1500, the comforting mode (stage 1800) is selected. The negative user input may be, for example, no response by the user 15 to the notification (step 1450) on the external device 15, failure to communicate via the network 40 with the external device 15, or the user selecting a negative response to the notification (e.g., if the user is in a business meeting).

At step 1900, the apparatus 400 checks whether the animal 10 has been comforted as a result of the comforting mode (step 1800). Indication that the animal 10 has been comforted may be, for example, but not limited to, the motion detector 455 determining the animal 10 has stopped moving (or left), the microphone 440 no longer detecting a sound from the animal 10 (e.g., a bark, a meow, or a heartbeat), or other signals received by the components 440 through 460 of the input module 910.

If the processing unit 500 determines that the animal 10 has been comforted at step 1900, the apparatus 400, particularly the output module 900 of the apparatus 400, switches to operating in the standby mode (step 1100). On the other hand, if the processing unit 500 determines that the animal 10 has not been comforted, the apparatus 400 continues operating in comforting mode (step 1800).

The process 1000 is repeated continuously during operation of the apparatus 400, operating the apparatus 400, in particular the output module 900 of the apparatus 400, in the interacting mode (step 1600) and the comforting mode (step 1800) as needed, determined by the user input and the animal input. The user 15 is able to adjust the interval transmission using the external device 50, or changing the stored setting of the memory module 600 before departing from the house 11.

As to the manner of usage and operation of the present invention, the same should be apparent from the above description. Accordingly, no further discussion relating to the manner of usage and operation will be provided.

While an embodiment of the gas detector has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described, and that each embodiment is also provided with features that may be applicable to other embodiments. It is to be understood that the invention includes all such variations and modifications that fall within its spirit and scope. The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I/We claim:

1. An apparatus for comforting and interacting with an animal, the apparatus comprising:
a communication module operable to receive a user input from an external device;
an input module operable to receive an animal input from the animal;
an output module consisting of at least one selected from the group of a heat generator and a vibration generator; and
a processing unit configured to
receive the user input from the communication module;
receive the animal input from the input module; and
operate the output module based on at least one of the user input and the animal input,
transmit a signal based on the animal input to the external device using the communication module.

2. The apparatus of claim 1, the input module consisting of at least one selected from the group of a microphone, a camera, an actuator, and a motion sensor.

3. The apparatus of claim 1, the output module further consisting of a speaker and a display.

4. The apparatus of claim 1, wherein the processing unit is further configured to operate the output module in an interacting mode when the user input is positive and the animal input is positive.

5. The apparatus of claim 4, wherein the output module presents the user input to the animal during the interacting mode.

6. The apparatus of claim 1, wherein the processing unit is further configured to operate the output module in an comforting mode when the user input is negative and the animal input is positive.

7. The apparatus of claim 6, wherein the output module presents a stored setting to the animal during the comforting mode.

8. The apparatus of claim 5, further comprising a memory module operable to store the stored setting, wherein the stored setting consists of at least one of a user feature and an actuating interval.

9. The apparatus of claim 1, further comprising a battery operable to provide electrical power to the apparatus.

10. An system for comforting and interacting with an animal, the system comprising:
an application on an external device configured to
receive a user input,
transmit a first signal based on the user input,
receive a second signal from an apparatus, and
present information related to the animal based on the second signal;
the apparatus comprising
a communication module operable to receive the first signal, based on the user input, from the application and transmit the second signal, based on an animal input, to the application,
a memory module operable to store a stored setting,
an input module operable to receive the animal input,
an output module operable based on at least one of the user input from the application and the stored setting from the memory module, and
a processing unit configured to
operate the communication module, the memory module, the input module, and the output module,
determine whether to operate the output module in one of an interacting mode and a comforting mode based on at least one of the user input and the animal input, and
wherein the output module presents the user input to the animal during the interacting mode, and the output module presents the stored setting to the animal during the comforting mode.

11. The system of claim 10, the input module consisting of at least one selected from the group consisting of a microphone, a camera, an actuator, a motion sensor, and a sample vial.

12. The system of claim 10, the output module consisting of at least one selected from the group consisting of a speaker, a display, a heat generator, a vibration generator, and a laser.

13. The system of claim 10, wherein the processing unit is further configured to operate the output module in the interacting mode when the user input is positive and the animal input is positive.

14. The system of claim 10, wherein the processing unit is further configured to operate the output module in the comforting mode when the user input is negative and the animal input is positive.

15. The system of claim 10, wherein the processing unit is further configured to determine whether to operate the output module in a standby mode based on the user input and the animal input, wherein the output module presents neither the user input nor the stored setting to the animal during the standby mode.

16. The system of claim 15, wherein the processing unit is further configured to operate the output module in the standby mode when the animal input is negative.

17. A bed for an animal, the bed comprising:
an apparatus operable to provide comfort and interaction to the animal;
a top member having an aperture operable to removably receive the apparatus, the top member composed of at least one material; and
a bottom member having means for attaching to the top member, the bottom member composed of at least one material.

18. The bed of claim 17, wherein the at least one material is selected from the group consisting of fleece, silk, cotton, suede, nylon, polyester, down, foam, and filler.

19. The bed of claim 17, further comprising a toggle operable to attach an additional feature to the top member.

20. The bed of claim 17, further comprising a compartment located on at least one of the bottom member and the top member, the compartment operable to store objects.
